(19) United States
(12) Patent Application Publication
(10) Pub. No.: US 2019/0118625 A1
(43) Pub. Date: Apr. 25, 2019

(54) VEHICULAR DOOR RAIL

(71) Applicant: Richard Lee Tate, Yeagertown, PA (US)

(72) Inventor: Richard Lee Tate, Yeagertown, PA (US)

(21) Appl. No.: 16/167,246

(22) Filed: Oct. 22, 2018

Related U.S. Application Data
(60) Provisional application No. 62/574,983, filed on Oct. 20, 2017.

(51) Int. Cl. B60J 5/04; E05D 15/10

(52) U.S. Cl. CPC B60J 5/0472; E05D 15/101

(57) ABSTRACT

Vehicular door rails are presented including: an elongated body; a pivot joint positioned along a proximal end of the elongated body for pivotally coupling with a vehicle door frame; a latching element positioned along a distal end of the elongated body for latching with the vehicle door frame; and a latch handle positioned along a top surface of the elongated body and mechanically coupled with the latching element. In some embodiments, vehicular door rails further include: a strut positioned along and coupled with an underside surface of the elongated body for pivotally coupling with the vehicle door frame. In some embodiments, the strut is: a gas charged strut, a spring strut, a spring-loaded fluid strut, an air dampened strut, a hydraulic strut, a pneumatic strut, and any combination thereof.

### BACKGROUND

Off-road adventure travel has been around as long as men and women have wandered the earth. With the advent of the automobile, back country areas became more accessible to more people. The evolution of multi-wheel drive vehicles further increased access to remote areas. More recently, off-road adventure includes crossing terrain previously thought unpassable by vehicles. Rock crawling and high intensity venturing has evolved rapidly to carry passengers further and further into the wilderness.

One evolution to off-road travel is to remove doors to the vehicle or to create vehicles without doors so as to improve visibility and prevent trapping occupants in a vehicle. As is often the case, vehicles may encounter close obstacles to overcome. In those cases, excellent visibility is often the key to picking one's way over an obstacle. In addition, those obstacles may damage doors or otherwise obstruct egress from a vehicle thus trapping occupants in a potentially difficult or dangerous position. Unfortunately, removing doors or traveling in door-less vehicles introduces additional exposure to occupants of the vehicle. It may be desirable to provide occupant protection while maintaining visibility and egress ability.

As such vehicular door rails are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Vehicular door rails are presented including: an elongated body; a pivot joint positioned along a proximal end of the elongated body for pivotally coupling with a vehicle door frame; a latching element positioned along a distal end of the elongated body for latching with the vehicle door frame; and a latch handle positioned along a top surface of the elongated body and mechanically coupled with the latching element. In some embodiments, vehicular door rails further include: a strut positioned along and coupled with an underside surface of the elongated body for pivotally coupling with the vehicle door frame. In some embodiments, the strut is: a gas charged strut, a spring strut, a spring-loaded fluid strut, an air dampened strut, a hydraulic strut, a pneumatic strut, and any combination thereof. In some embodiments, vehicular door rails further include: a pivot adapter mechanically coupled with the vehicle door frame along a top door hinge position of the vehicle. In some embodiments, vehicular door rails further include: a strut adapter mechanically coupled with the vehicle door frame along a bottom door hinge position of the vehicle. In some embodiments, vehicular door rails further include: a combination pivot/strut adapter mechanically coupled with the vehicle door frame along a top door hinge position and a bottom door hinge position of the vehicle. In some embodiments, the elongated body is manufactured from: a round tubing, a straight oval tubing, an elliptical tubing, a square tubing, and a rectangular tubing.

In other embodiments, methods of using a vehicular door rail are presented including: providing a vehicle; providing a vehicular door rail, the vehicular door rail including: an elongated body, a pivot joint positioned along a proximal end of the elongated body for pivotally coupling with a vehicle door frame, a latching element positioned along a distal end of the elongated body for latching with the vehicle door frame, and a latch handle positioned along a top surface of the elongated body and mechanically coupled with the latching element; and installing the vehicular door rail on the vehicle along the vehicle door frame. In some embodiments, methods further include: pivoting the vehicular door rail to a horizontal position; and latching the vehicular door rail with the vehicle door frame to provide a safety barrier for the vehicle. In some embodiments, methods further include: unlatching the vehicular door rail from the vehicle door frame; and raising the vehicular door rail by vertically pivoting the vehicular door rail to provide unhindered access to the vehicle. In some embodiments, the installing the vehicular door rail on the vehicle includes: if the vehicle has a vehicle door, removing the vehicle door; mechanically coupling a pivot adapter with the vehicle door frame along a top door hinge position of the vehicle; mechanically coupling a strut adapter mechanically with the vehicle door frame along a bottom door hinge position of the vehicle; pivotally coupling the elongated body with the pivot adapter; and pivotally coupling a strut with the elongated body and the strut adapter.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of an installed vehicular door rail in accordance with embodiments of the present invention;

FIGS. 2A-2D are illustrative representations of different views of a vehicular door rail in accordance with embodiments of the present invention;

FIG. 3 is an illustrative representation of a strut adapter for use with vehicular door rails in accordance with embodiments of the present invention;

FIG. 4 is an illustrative representation of a pivot adapter for use with vehicular door rails in accordance with embodiments of the present invention;

FIG. 5 is an illustrative representation of a combination pivot/strut adapter for use with vehicular door rails in accordance with embodiments of the present invention; and

FIG. 6 is an illustrative representation of a bump stop for use with vehicular door rails in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In still other instances, specific numeric references such as “first material,” may be made. However, the specific numeric reference should not be interpreted as a literal sequential order but rather interpreted that the “first material” is different than a “second material.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

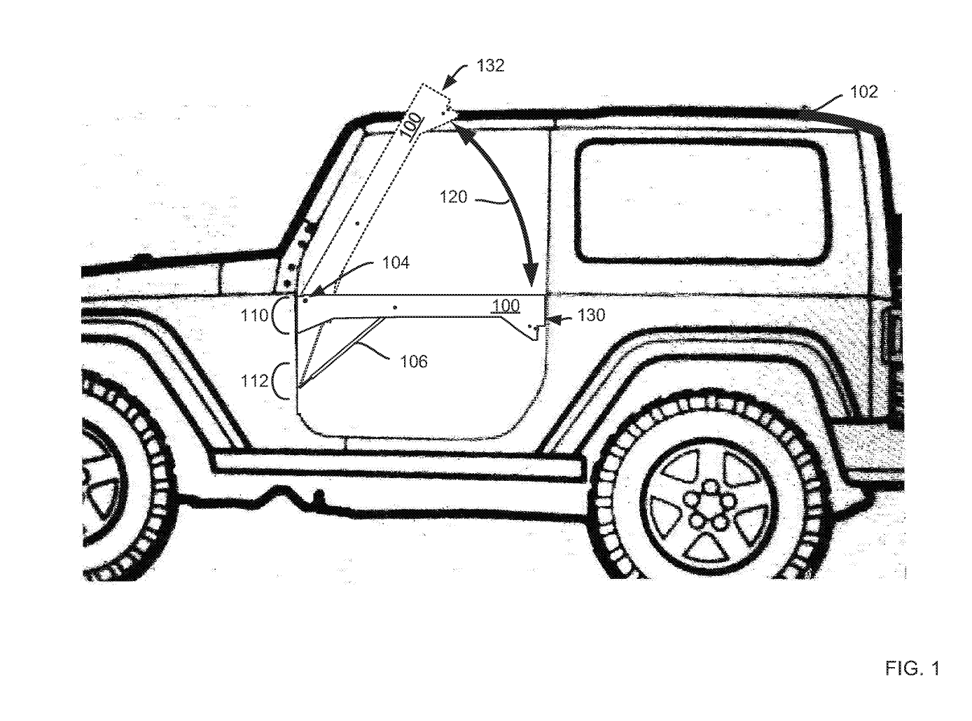

FIG. 1 is an illustrative representation of an installed vehicular door rail 100 in accordance with embodiments of the present invention. As illustrated vehicular door rail 100 is shown in closed position 130 on vehicle 102. In closed position, vehicular door rail embodiments provide additional protection to drivers and passengers. As noted above, it is common for off-road enthusiasts to remove doors from stock vehicles or simply to have a custom fabricated vehicle with no doors. While doors provide a level of protection for vehicle occupants, they may also obstruct the view of the driver and block egress from the vehicle when they are damaged. Vehicle door rails provide protection for the occupants while also allowing unobstructed view of obstacles and easy egress from the vehicle. As illustrated, vehicle door rail 100 may be raised vertically 120 to open position 132 to allow egress from the vehicle. Unlike conventional or stock doors, vehicle door rail embodiments open upwardly with little or no horizontal movement. In an outdoor environment, narrow passages or close contact with obstacles would otherwise block egress with a conventional door potentially trapping the occupants in a dangerous position. Because vehicle door rail embodiments open vertically, trapping the occupants is nearly non-existent. Vertical movement is made possible by pivot joint 104 that is mechanically coupled with the vehicle's door frame along top door hinge position 110 of vehicle 102. Vertical movement may be assisted or damped by strut 106 that is positioned along and coupled with an underside surface of the vehicle door rail body and mechanically coupled with the vehicle door frame along bottom door hinge position 112 of vehicle 102. In embodiments, struts include: a gas charged strut, a spring strut, a spring-loaded fluid strut, an air dampened strut, a hydraulic strut, a pneumatic strut, and any combination thereof.

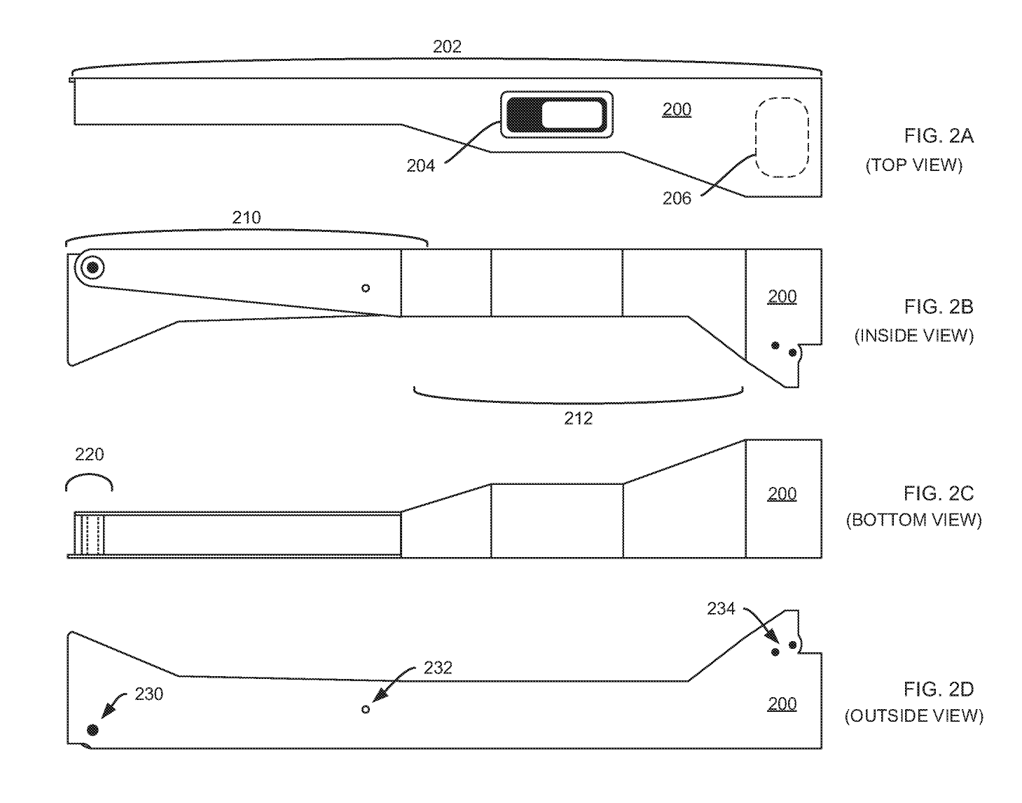

FIGS. 2A-2D are illustrative representations of different views of vehicular door rail 200 in accordance with embodiments of the present invention. In particular, FIG. 2A is a top view of vehicular door rail 200; FIG. 2B is an inside view of vehicular door rail 200; FIG. 2C is a bottom view of vehicular door rail 200; and FIG. 2D is an outside view of vehicular door rail 200. The various views are presented in rotation. As illustrated vehicular door rail 200 includes elongated body 202. As illustrated, elongated body is a boxed frame embodiment. In other embodiments, elongated body may also be manufactured from a variety of tubing such as, for example, a round tubing, a straight oval tubing, an elliptical tubing, a square tubing, and a rectangular tubing without limitation. In addition, tubing may be manufactured by a variety of materials including: steel, stainless steel, aluminum, polymeric compounds, carbon fiber added compounds and the like without limitation in embodiments disclosed herein. Further illustrated is latch handle 204 positioned along a top surface of elongated body 202 and mechanically coupled with latching element 206 positioned along a distal end of the elongated body for latching with a vehicle door frame. Latching elements and latch handles are well-known in the art and, as such, any suitable combination may be utilized in embodiments. In some embodiments, latch handle and latching element are coupled via a cable or a rod.

Further illustrated are mounting areas 210 and 212. In some embodiments, it may be desirable to mount additional accessories to the elongated body. Area 210 represents a top surface area of elongated body 202 where a rearview mirror or spotlight may be mounted. In addition, area 212 represents a bottom surface area of elongated body 202 where a light or lightbar may be mounted to provide additional illumination. Rearview mirrors, spotlights, lights, and lightbars are well-known in the art and may be utilized in any combination in embodiments without limitation. In embodiments, accessories may be mounted via surface holes in the surfaces illustrated, by raised tabs on surfaces illustrated, or by clamping bolts without limitation.

Further illustrated is pivot joint 220 positioned along a proximal end of elongated body 200 for pivotally coupling with a vehicle door frame. Pivot joint embodiments provide vertical movement of a vehicle door rail. Importantly, pivot joints limit horizontal movement of vehicle door rail embodiments so that the vehicle door rail may be raised without interference with close obstacles. Pivot joint embodiments may include bushings made of a variety of materials such as, brass, steel, high density polyethylene, polymeric compounds, and aluminum without limitation. Still further illustrated are pivot attachment point 230, strut attachment point 232, and latching element attachment point 234 as shown along outside surface of elongated body 202.

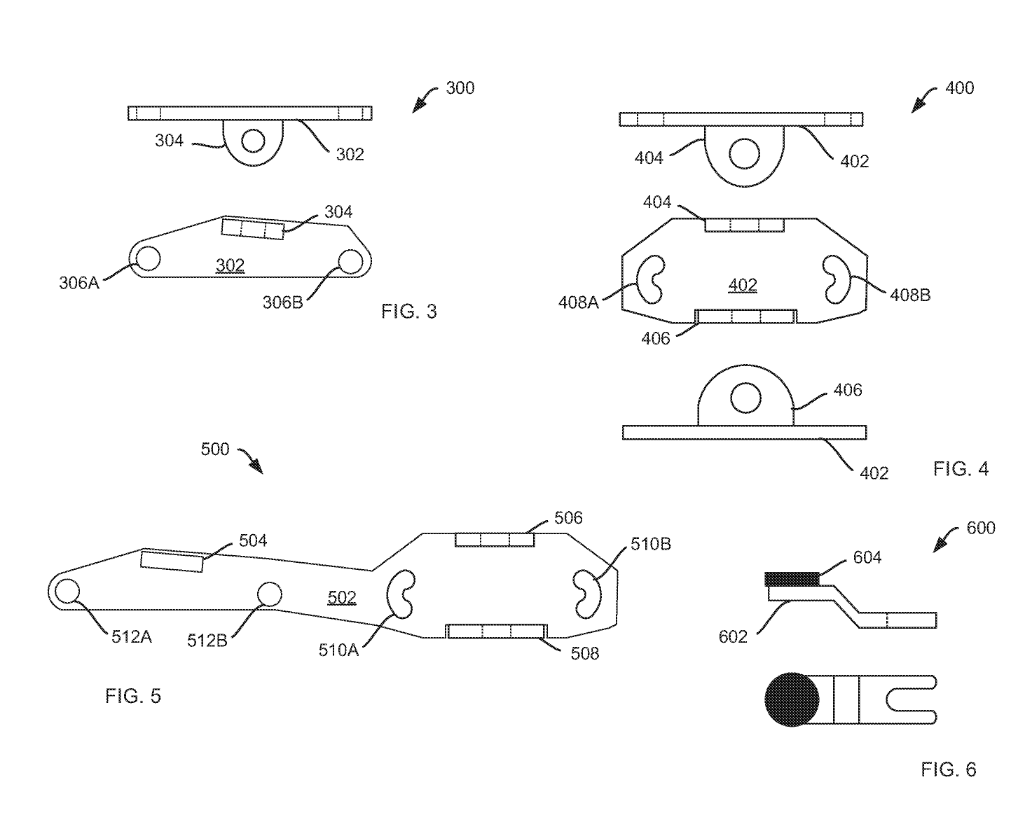

FIG. 3 is an illustrative representation of strut adapter 300 for use with vehicular door rails in accordance with embodiments of the present invention. As illustrated, strut adapter 300 includes base 302 and strut connecting tab 304. In embodiments, strut adapter 300 mechanically couples with the vehicle door frame along a bottom door hinge position of the vehicle via mounting holes 306A and 306B. In this manner, the stock hinge mounting may be utilized to receive and mount strut adapter embodiments without further modification to the stock configuration. In custom fabrication examples, strut adapter embodiments may be placed and mounted in any suitable manner and location.

FIG. 4 is an illustrative representation of pivot adapter 400 for use with vehicular door rails in accordance with embodiments of the present invention. As illustrated, pivot adapter 400 includes base 402 and pivot connecting tabs 404 and 406. In embodiments, pivot adapter 400 mechanically couples with the vehicle door frame along a top door hinge position of the vehicle via mounting holes 408A and 408B. In this manner, the stock hinge mounting may be utilized to receive and mount pivot adapter embodiments without further modification to the stock configuration. In custom fabrication examples, pivot adapter embodiments may be placed and mounted in any suitable manner and location. Mounting holes 408A and 408B are lobed so that the camber of the vehicular door rail may be suitably adjusted during fitment.

FIG. 5 is an illustrative representation of a combination pivot/strut adapter 500 for use with vehicular door rails in accordance with embodiments of the present invention. As illustrated, combination pivot/strut adapter 500 includes base 502, strut connecting tab 504 and pivot connecting tabs 506 and 508. In embodiments, combination pivot/strut adapter 500 mechanically couples with the vehicle door frame along a bottom door hinge position of the vehicle via mounting holes 512A and 512B and with the vehicle door frame along a top door hinge position of the vehicle via mounting holes 510A and 510B. As above, the stock hinge mountings may be utilized to receive and mount combination pivot/strut adapter embodiments without further modification to the stock configuration. In custom fabrication examples, combination pivot/strut adapter embodiments may be placed and mounted in any suitable manner and location. Mounting holes 510A and 510B are lobed so that the camber of the vehicular door rail may be suitably adjusted during fitment.

FIG. 6 is an illustrative representation of bump stop 600 for use with vehicular door rails in accordance with embodiments of the present invention. As illustrated, bump stop 600 includes base 602 and pad 604. Any pad material known in the art may be utilized without limitation in embodiments. For example, pad materials may include: rubber, polymeric compounds, silicone, felt, and the like. Bump stop embodiments may be positioned along a top mounting hole of a pivot adapter or combination pivot/strut adapter. The bump stop is so positioned to stop vertical movement of a vehicle door rail embodiment as to avoid a potentially damaging hard stop.

Methods of Use

In embodiments, vehicle door rails may be utilized in at least the following manner:

providing a vehicle;

providing a vehicular door rail; and

installing the vehicular door rail on the vehicle along the vehicle door frame, where the installing includes:
if the vehicle has a vehicle door, removing the vehicle door;
mechanically coupling a pivot adapter with the vehicle door frame along a top door hinge position of the vehicle;
mechanically coupling a strut adapter mechanically with the vehicle door frame along a bottom door hinge position of the vehicle;
pivotally coupling the elongated body with the pivot adapter; and
pivotally coupling a strut with the elongated body and the strut adapter.

In use, methods further include:

pivoting the vehicular door rail to a horizontal position;

latching the vehicular door rail with the vehicle door frame to provide a safety barrier for the vehicle (see FIG. 1; closed position 130);

unlatching the vehicular door rail from the vehicle door frame; and

raising the vehicular door rail by vertically pivoting the vehicular door rail to provide unhindered access to the vehicle (see FIG. 1; open position 132).

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A vehicular door rail comprising:
an elongated body;
a pivot joint positioned along a proximal end of the elongated body for pivotally coupling with a vehicle door frame;
a latching element positioned along a distal end of the elongated body for latching with the vehicle door frame; and
a latch handle positioned along a top surface of the elongated body and mechanically coupled with the latching element.

2. The vehicular door rail of claim 1, further comprising:
a strut positioned along and coupled with an underside surface of the elongated body for pivotally coupling with the vehicle door frame.

3. The vehicular door rail of claim 2, wherein the strut is selected from the group consisting of: a gas charged strut, a spring strut, a spring-loaded fluid strut, an air dampened strut, a hydraulic strut, a pneumatic strut, and any combination thereof.

4. The vehicular door rail of claim 1, further comprising:
a pivot adapter mechanically coupled with the vehicle door frame along a top door hinge position of the vehicle.

5. The vehicular door rail of claim 2, further comprising:
a strut adapter mechanically coupled with the vehicle door frame along a bottom door hinge position of the vehicle.

6. The vehicular door rail of claim 2, further comprising:
a combination pivot/strut adapter mechanically coupled with the vehicle door frame along a top door hinge position and a bottom door hinge position of the vehicle.

7. The vehicular door rail of claim 1, wherein the elongated body is manufactured from a tubing selected from the group consisting of: a round tubing, a straight oval tubing, an elliptical tubing, a square tubing, and a rectangular tubing.

8. A method of using a vehicular door rail comprising:
providing a vehicle;
providing a vehicular door rail, the vehicular door rail comprising:
an elongated body,
a pivot joint positioned along a proximal end of the elongated body for pivotally coupling with a vehicle door frame,
a latching element positioned along a distal end of the elongated body for latching with the vehicle door frame, and
a latch handle positioned along a top surface of the elongated body and mechanically coupled with the latching element; and
installing the vehicular door rail on the vehicle along the vehicle door frame.

9. The method of claim 8, further comprising:
pivoting the vehicular door rail to a horizontal position; and
latching the vehicular door rail with the vehicle door frame to provide a safety barrier for the vehicle.

10. The method of claim 9, further comprising:
unlatching the vehicular door rail from the vehicle door frame; and
raising the vehicular door rail by vertically pivoting the vehicular door rail to provide unhindered access to the vehicle.

11. The method of claim 8, wherein the installing the vehicular door rail on the vehicle comprises:
if the vehicle has a vehicle door, removing the vehicle door;
mechanically coupling a pivot adapter with the vehicle door frame along a top door hinge position of the vehicle;
mechanically coupling a strut adapter mechanically with the vehicle door frame along a bottom door hinge position of the vehicle;
pivotally coupling the elongated body with the pivot adapter; and
pivotally coupling a strut with the elongated body and the strut adapter.

12. The method of claim 11, wherein the strut is selected from the group consisting of: a gas strut, a spring strut, and a combination thereof.
